(19) United States
(12) Patent Application Publication
(10) Pub. No.: US 2018/0065828 A1
(43) Pub. Date: Mar. 8, 2018

(54) WIRE-SHAPED BODY WINDING MECHANISM AND MOTION PLATFORM HAVING THE SAME

(71) Applicant: HIWIN MIKROSYSTEM CORP., Taichung City (TW)

(72) Inventors: Yung-Tsai CHUO, Taichung City (TW); Chi-Pin CHOU, Taichung City (TW)

(21) Appl. No.: 15/255,354

(22) Filed: Sep. 2, 2016

(51) Int. Cl. B65H 75/38; B65H 75/44; H02G 11/02

(52) U.S. Cl. CPC B65H 75/38; B65H 2701/34; H02G 11/02; B65H 75/4471

(57) ABSTRACT

A wire-shaped body winding mechanism provided by the present invention includes multiple rotary shafts for winding a wire-shaped body, where a main shaft member serves as a revolution central shaft and two split shaft members serve as rotation central shafts. The wire-shaped body is wound on the split shaft members and thus can be coiled or released with rotation of the main shaft member. Relative movement between the split shaft members and the wire-shaped body is realized through rotation of the split shaft members, and thus the wire-shaped body can move smoothly.

### BACKGROUND OF THE INVENTION

### 1. Field of the Invention

The present invention relates to winding technologies of flexible wire-shaped bodies, and more particularly to a wire-shaped body winding mechanism and a motion platform having the same.

2. Description of the Related Art

As for the prior art that flexible wire-shaped bodies such as threads, cords, ropes, water pipes, gas pipes, cables, wires and optical fibers are coiled with a turnplate, a specific example is shown in FIG. 1, where a wire-shaped body (1) is fixed on a turnplate (2) on one side and is reversely wound on a rotary shaft (3) of the turnplate (2), such that the wire-shaped body (1) is wound on the rotary shaft (3) in sync with rotation of the turnplate (2) and the rotary shaft (3). However, the wire-shaped body (1) maybe easily twisted and broken during reverse winding. To solve the above problem, rotary connection technologies such as an air-compression rotary joint, an electronic slip ring and an electric brush are used in the prior art to compensate the twisting of the wire-shaped body during reverse winding, such that the wire-shaped body is prevented from being twisted and broken.

In the above related art for preventing the wire-shaped body from being twisted and broken, the air-compression rotary joint can only be applied to a delivery pipeline for compressed air; and although the electronic slip ring and the electric brush can be applied in the technical field of electric power supply, noises produced in operation may cause interference to signal transmission, and thus the electronic slip ring and the electric brush cannot be applied to cables for signal transmission. In other words, the related art for solving the problem of twisting and breaking of a wire-shaped body in the prior art can only be implemented in specific technical scopes and cannot be applied in other technical fields.

In addition, for example, when the wire-shaped body serves as a channel for electric power or signal transmission, the prior art for coiling the wire-shaped body is shown in FIG. 1, where a connector such as a socket (4) is disposed on a turnplate (2) for connection to an external line. However, the socket (4) rotates with the turnplate (2) during coiling, and therefore, to prevent the external line from being twisted, the external line needs to be disconnected before the turnplate rotates and then the wire-shaped body is coiled or pulled out, resulting in limitations in use.

### SUMMARY OF THE INVENTION

Therefore, the present invention is mainly directed to provide a wire-shaped body winding mechanism, to reduce the probability that a wire-shaped body coiled by the mechanism and an external line connected to the mechanism are twisted and broken.

To achieve the above objective, the wire-shaped body winding mechanism provided by the present invention operates on the basis of a base member, and the base member rotates about a main shaft as a rotary shaft to enable winding of the wire-shaped body; two support members are separately arranged on one end of the base member corresponding to the rotary shaft, and the support members move in sync with rotation of the base member, such that the wire-shaped body to be coiled is wound on the support members in an interlaced manner, the base member is made to rotate forward along the coiling direction and thus the wire-shaped body is reversely wound on the support members; and on the contrary, the base member may also be made to rotate in a direction opposite to the coiling direction, and thus the wire-shaped body coiled on the support members is loosened from the support members.

To make the wire-shaped body reversely wound on the support members in an overlapping manner, the support members and the wire-shaped body to be coiled are in rolling or slidable connection so as to move relative to each other.

In the rolling connection, each support member rotates on the base member about a split shaft, and each split shaft is parallel to the main shaft.

In the slidable connection, each support member has a coiling surface with a low friction coefficient for slidable connection to the wire-shaped body to be coiled.

The base member has a first limiting end surface and a second limiting end surface. The second limiting end surface is separated from the first limiting end surface in the axial direction of the main shaft so as to form a limiting space, and the support members are disposed in the limiting space.

Further, to enable the base member to rotate about the main shaft, an elastic member is required to provide the desired driving force, and specifically, the elastic member maybe a volute spring, a torsion spring or any other elastic element that provides an elastic force to enable the base member to rotate forward along the coiling direction.

The present invention also provides a motion platform having the wire-shaped body winding mechanism. The motion platform includes a fixed seat, a movable seat, a wire-shaped body winding mechanism and a wire-shaped body. The movable seat is slidably disposed on the fixed seat and capable of performing reciprocating displacement linearly, the wire-shaped body winding mechanism is fixedly or slidably disposed on the fixed seat, and the wire-shaped body is wound in the winding mechanism and has one end electrically connected to the movable seat.

### BRIEF DESCRIPTION OF THE DRAWINGS

FIG. 1 is a schematic view of operation of a conventional winding mechanism.

FIG. 2 is an assembly view of an embodiment of a wire-shaped body winding mechanism disclosed by the present invention.

FIG. 3 is an exploded view of the embodiment of the wire-shaped body winding mechanism disclosed by the present invention.

FIG. 4 is a cross-sectional view along the section line 4-4 in FIG. 2 according to the embodiment of the wire-shaped body winding mechanism disclosed by the present invention.

FIG. 5 is a cross-sectional view along the section line 5-5 in FIG. 2 according to the embodiment of the wire-shaped body winding mechanism disclosed by the present invention.

FIG. 6 is a schematic view showing a state that the wire-shaped body is completely coiled according to the embodiment of the wire-shaped body winding mechanism disclosed by the present invention.

FIG. 7 is a schematic view showing a state that the wire-shaped body is being continuously coiled according to the embodiment of the wire-shaped body winding mechanism disclosed by the present invention.

FIG. 8 is a schematic view showing a state that the wire-shaped body is completely pulled out according to the embodiment of the wire-shaped body winding mechanism disclosed by the present invention.

FIG. 9 is a schematic view of an application where the embodiment of the wire-shaped body winding mechanism disclosed by the present invention is applied on a motion platform.

FIG. 10 is a schematic view of another application where the embodiment of the wire-shaped body winding mechanism disclosed by the present invention is applied on the motion platform.

FIG. 11 is a schematic view of another application where the embodiment of the wire-shaped body winding mechanism disclosed by the present invention is applied on the motion platform.

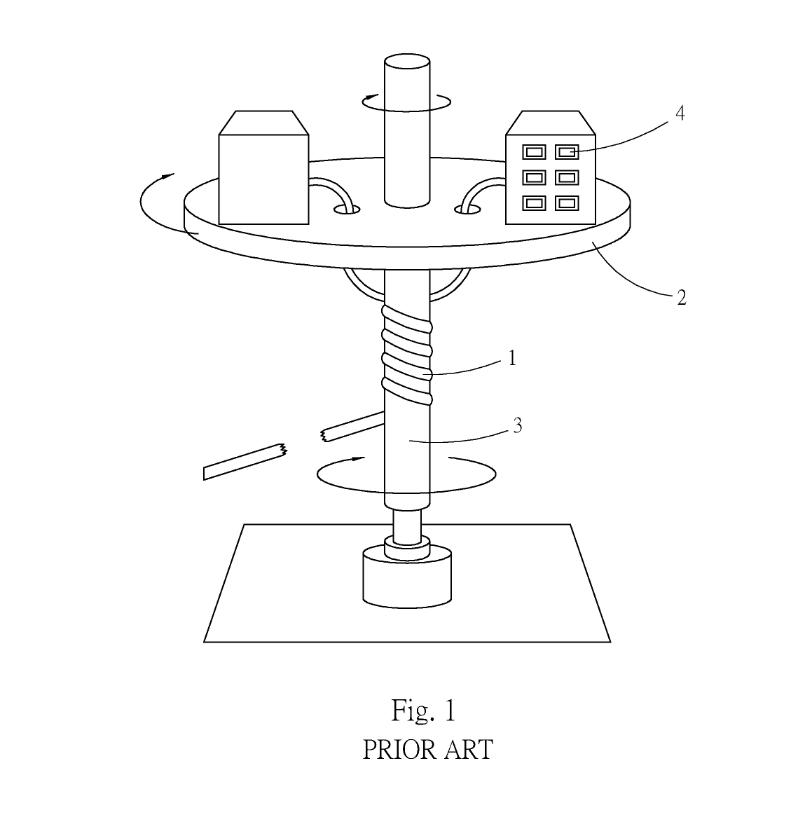

### DETAILED DESCRIPTION OF THE PREFERRED EMBODIMENTS

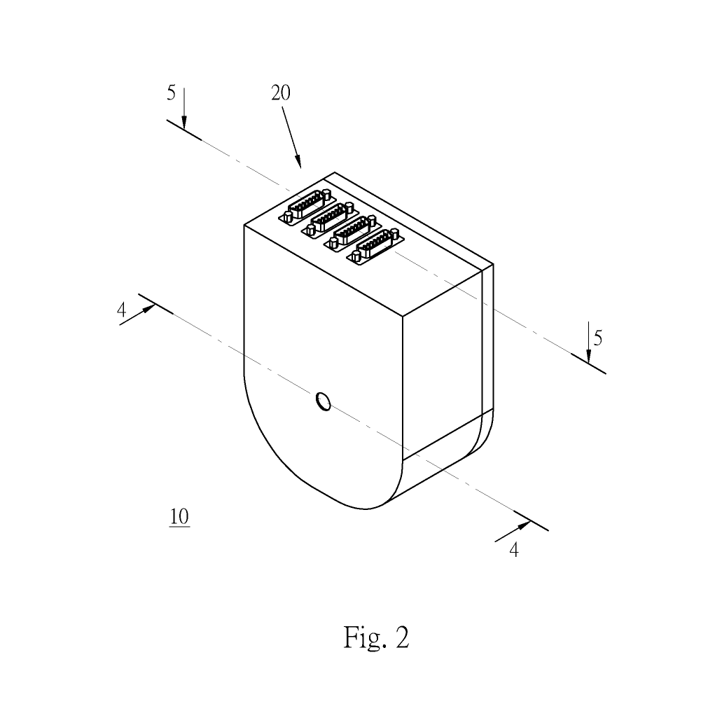

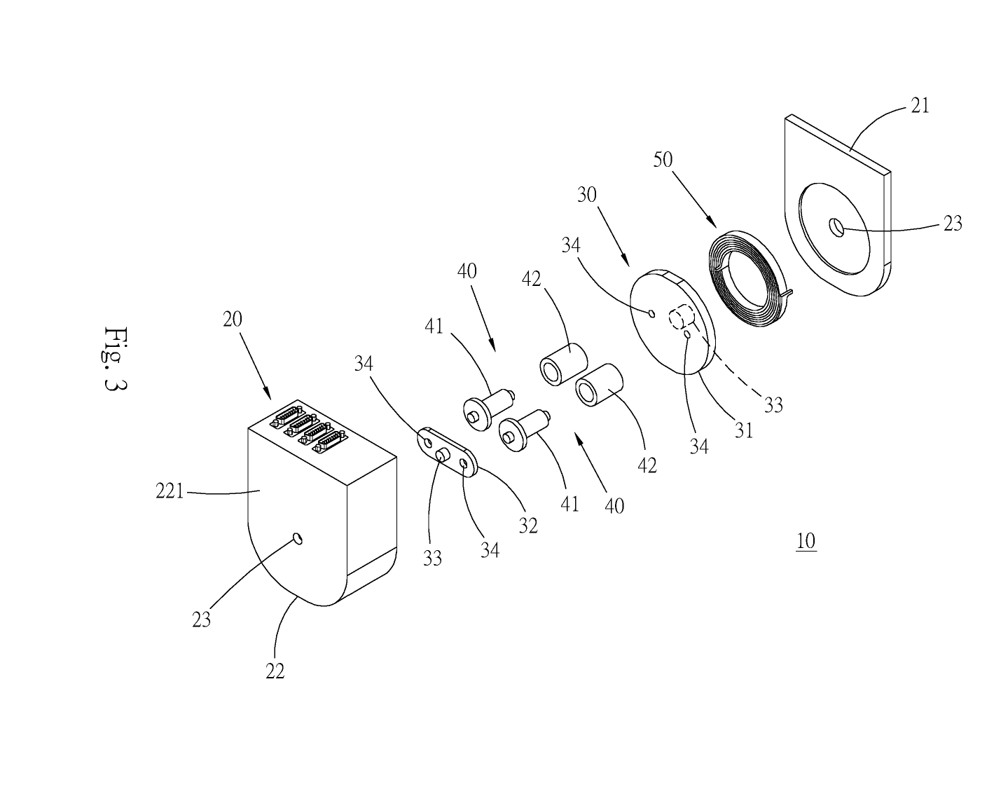

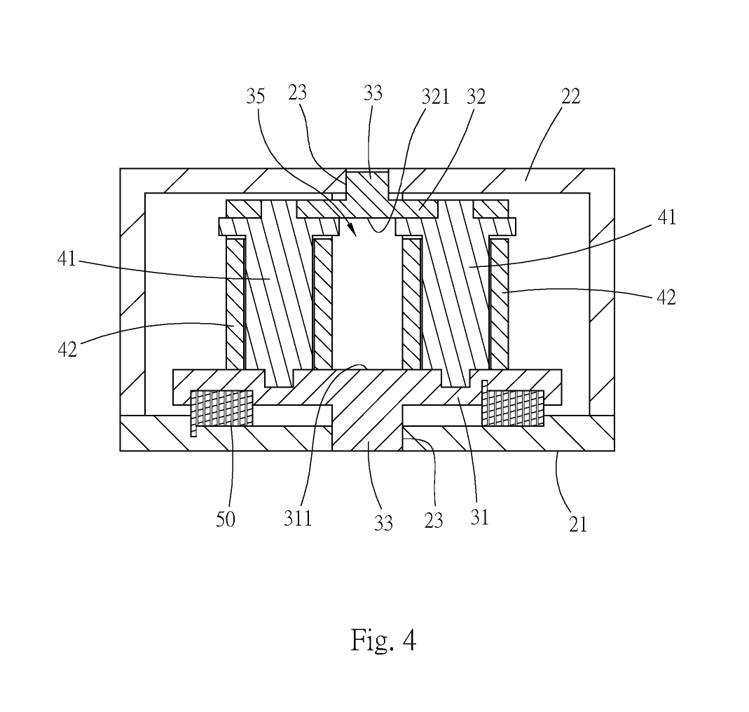

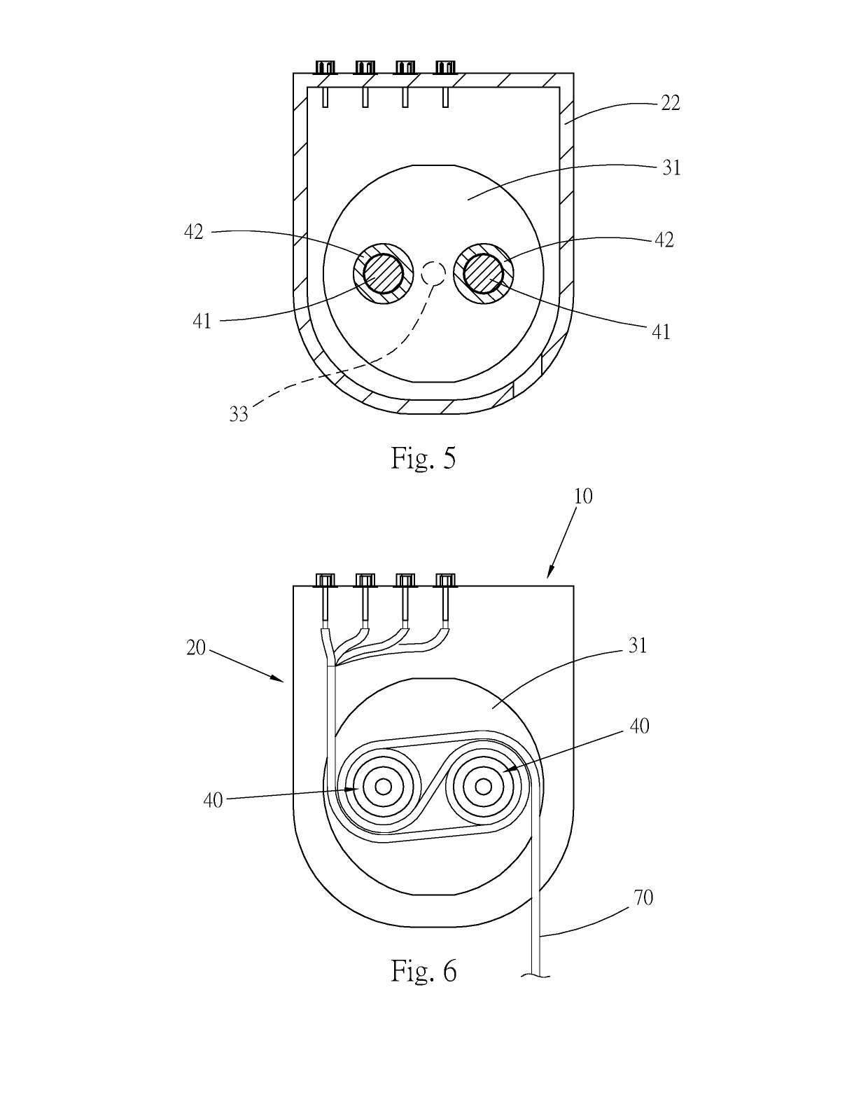

Referring to FIG. 2 to FIG. 5, a wire-shaped body winding mechanism (10) provided in an embodiment of the present invention mainly includes a housing seat (20), a base member (30), two support members (40), and an elastic member (50).

The housing seat (20) has an end body (21), a housing (22) and two axle holes (23). The end body (21) is in the shape of a plate, the housing (22) is in the shape of a hollow cap, the end body (21) is abutted against the housing (22), and an accommodating space of an appropriate volume is formed between the end body (21) and the housing (22) and is used for accommodating constituting elements except the housing seat and accommodating the wire-shaped body to be coiled. The two axle holes (23) are coaxially and correspondingly arranged on the end body (21) and an opposite housing plate (221) of the housing (22) away from the end body.

The base member (30) is located in the accommodating space of the housing seat (20), and has a turnplate (31), an adapter (32), two axle protrusions (33) and two pairs of combining holes (34). The turnplate (31) and the adapter (32) are both in the shape of a plate and are located in parallel in the accommodating space. The turnplate (31) is adjacent to the end body (21), and the adapter (32) is adjacent to the opposite housing plate (221). The axle protrusions (33) are coaxially arranged on one side of the turnplate (31) facing the end body (21) and arranged on one side of the adapter (32) facing the opposite housing plate (221) in a protruding manner, and respectively penetrate the corresponding axle holes (23), such that the turnplate (31) and the adapter (32) rotate relative to the housing seat (20) via the axle protrusions (33) respectively. For the whole base member (30), the coaxially arranged axle protrusions (33) form a main shaft, and the base member (30) rotates about the main shaft. The pairs of combining holes (34) are coaxially distributed on the turnplate (31) and the adapter (32).

A limiting space (35) is formed between the turnplate (31) and the adapter (32) and has an appropriate height, and is specifically arranged between a first limiting end surface (311) of the turnplate (31) facing the adapter (32) and a second limiting end surface (321) of the adapter (32) facing the turnplate (31).

Each support member (40) is disposed between the turnplate (31) and the adapter (32), and has a support shaft (41) and a rolling sleeve (42). The support shafts (41) are rod-like and parallel to each other, the two ends of a rod shaft of each support shaft (41) penetrate the corresponding pair of the combining holes (34), and thus the support shaft (41) is sandwiched and positioned between the turnplate (31) and the adapter (32). Each rolling sleeve (42) is tubular and has an appropriate outer diameter, and is sleeved on the corresponding support shaft (41) and capable of rotating on the sleeved support shaft. In other words, the rod shaft of each support shaft (41) forms a split shaft parallel to the main shaft, and each rolling sleeve (42) is enabled to rotate about the corresponding split shaft.

The elastic member (50) is an annular volute spring sandwiched between the turnplate (31) and the end body (21), the two ends of the volute spring are respectively retained and connected to the turnplate (31) and the end body (21), and therefore a restoring elastic force is provided for rotation of the turnplate (31) and is continuously applied on the base member (30), such that the base member (30) normally rotates in the coiling direction when rotating about the main shaft.

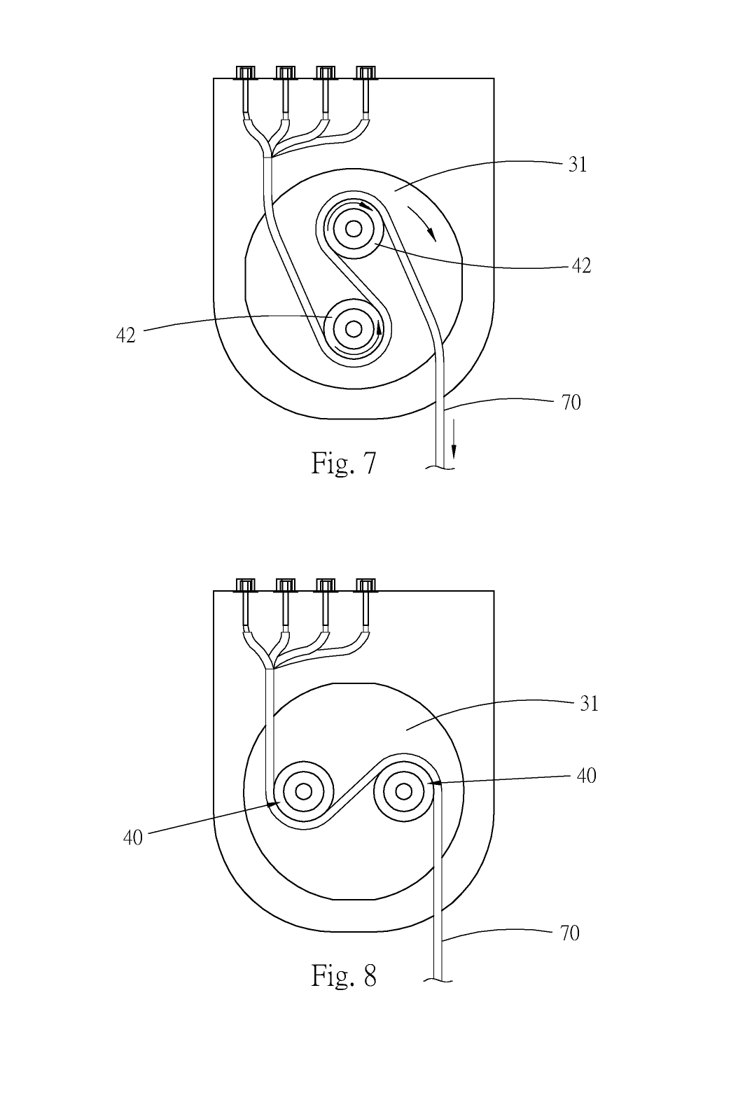

According to the construction of the above members, when the wire-shaped body winding mechanism (10) is used, as shown in FIG. 6 and FIG. 7, one end of a wire-shaped body (70) in the shape of a flat plate is disposed in the accommodating space and is electrically connected to a connecting terminal located on one side of the housing seat (20), and the other end of the wire-shaped body (70) is wound around the support members (40) in an interlaced manner in the limiting space (35) and then extends out from the opening on the other side of the housing seat (20) so as to be electrically connected to other external devices or mechanisms. In this manner, the wire-shaped body (70) can serve as a transmission channel for electrical signals, and compared with the prior art that the electronic slip ring and the electric brush may easily cause interference, the integrity of the wire-shaped body (70) is maintained and no additional interference is resulted.

Further, when the wire-shaped body (70) is connected to the wire-shaped body winding mechanism (10) and is not affected by any external force, as shown in FIG. 6, the base member (30) continuously rotates in the coiling direction under the effect of the elastic force of the elastic member (50), the windable part of the wire-shaped body (70) can be completely coiled into the accommodating space, and limited by the condition that the height of the limiting space (35) is approximate to the outer diameter of the wire-shaped body (70), the wire-shaped body (70) can be sequentially stacked during coiling without being twisted.

When an external pulling force is applied on the wire-shaped body (70), the base member (30) is driven to rotate in a direction opposite to the coiling direction so as to conform to the change of the relative spatial position when the wire-shaped body (70) is loosened. As shown in FIG. 7, when the wire-shaped body (70) is pulled out or coiled, because the support members (40) revolve about the main shaft, the wire-shaped body (70) may be damaged if the resistance between the support members (40) and the wire-shaped body (70) during relative displacement when the position changes is not appropriately eliminated. Therefore, the rolling sleeves (42) are enabled to rotate when the support members (40) revolve in the present embodiment, so as to reduce the resistance between the surfaces of the rolling sleeves (42) and the wire-shaped body and thus the wire-shaped body (70) can be smoothly and completely pulled out as shown in FIG. 8.

It should be noted that, in addition to the above embodiment where the support members rotate to be in rolling contact with the wire-shaped body, the coiling surface, in contact with the wire-shaped body, of each support member may also be treated properly to have a low friction coefficient, such that the coiling surface is in slidable connection to the wire-shaped body with low friction.

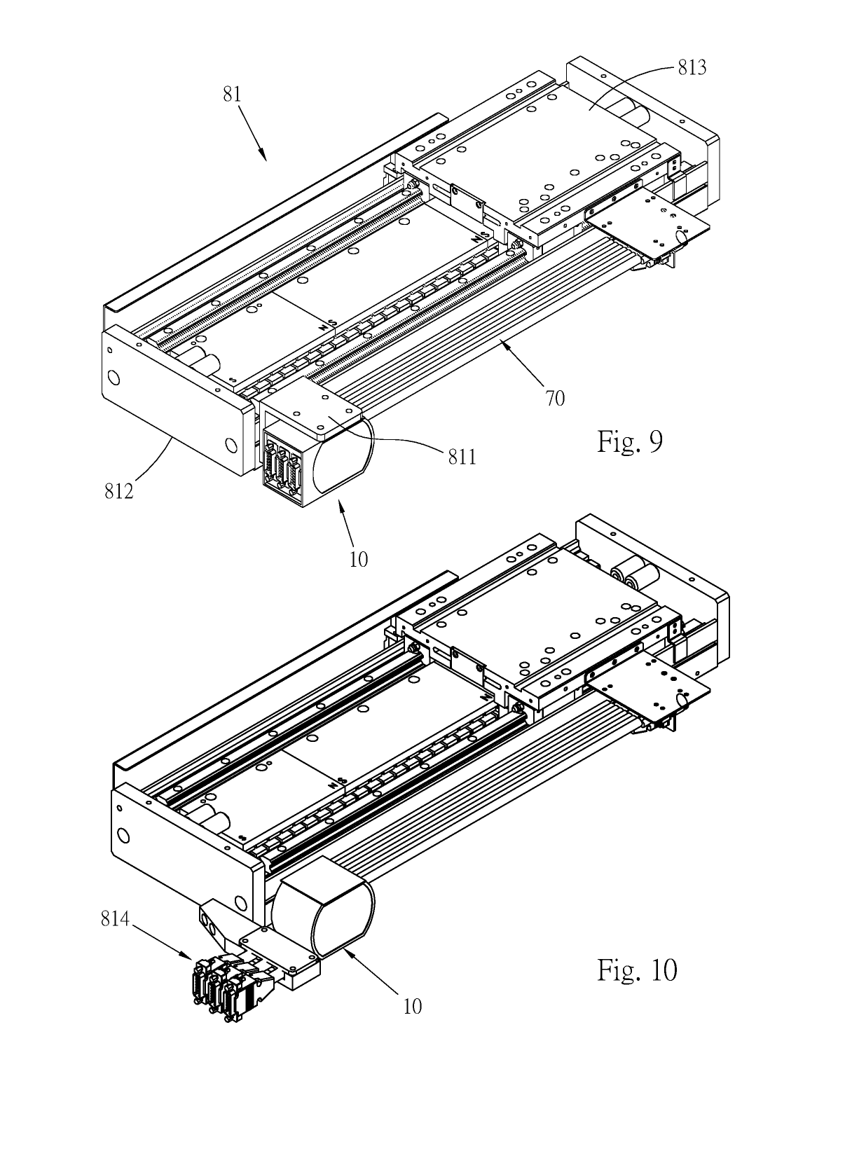

In a specific application example, the wire-shaped body winding mechanism (10) may be applied on a motion platform to coil a cable for signal transmission. Specifically, as shown in FIG. 9, the wire-shaped body winding mechanism (10) is applied on a motion platform (81), the housing seat (20) is fixed on a fixed seat (812) of the motion platform (81) through a fixing plate (811), and one end of the wire-shaped body (70) to be coiled is electrically connected to a connector of the movable seat (813) of the motion platform (81). Therefore, when the movable seat (813) performs reciprocating movement linearly, an external force may be provided to pull the wire-shaped body (70) outward, and when the movable seat (813) performs reciprocating displacement, the wire-shaped body (70) is coiled under the effect of the elastic force provided by the elastic member (50). In this way, the motion platform (81) is clear of any undesired and scattered wire-shaped materials, which prevents hindering the movement of the motion platform and improves the operating security.

In the above application example, the connector electrically connected to the other end of the wire-shaped body (70) is disposed in the winding mechanism. Besides, as shown in FIG. 10, the connector (814) electrically connected to one end of the wire-shaped body (70) may be independently disposed outside the winding mechanism (10), which does not affect the efficacy of the wire-shaped body winding mechanism (10) applied on the motion platform.

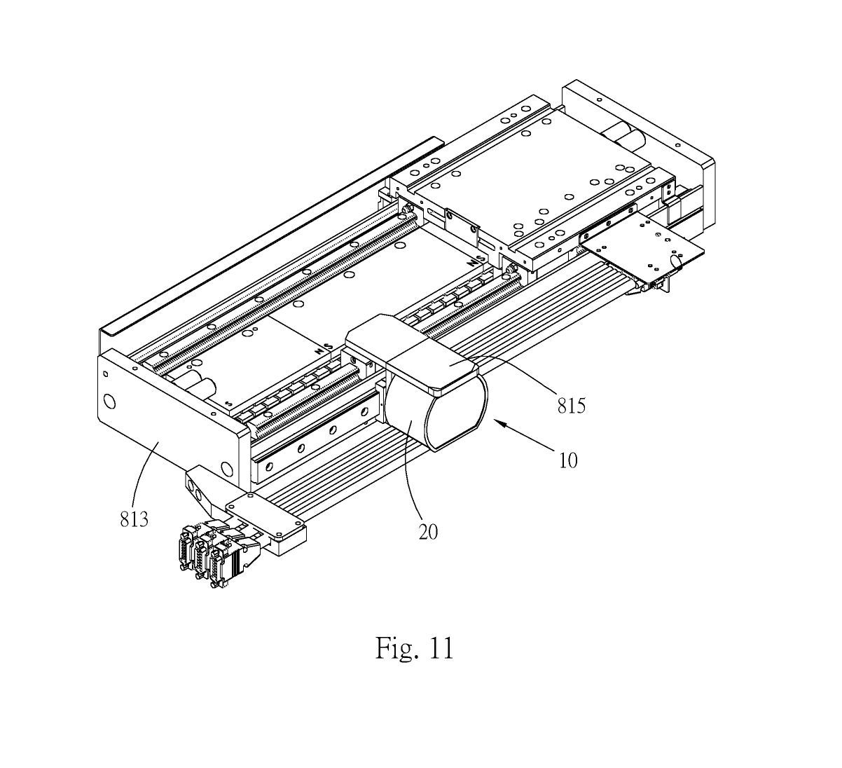

Further referring to FIG. 11, in the application of the wire-shaped body winding mechanism (10), different from the fixing manner in FIG. 10, the housing seat (20) is slidably connected to the fixed seat (812) of the motion platform through a connecting plate (815), and can slide on the fixed seat (812) while being independent from the movable seat (813). Therefore, when the wire-shaped body (70) is coiled under an external force, the housing seat (20) may be driven to slide on the fixed seat (812) in sync with the coiling or pull-out of the wire-shaped body (70), the coiling operation can be uniformly implemented on two sides, and thus the service life of the wire-shaped material is prolonged.

What is claimed is:

1. A wire-shaped body winding mechanism, comprising:
a base member, rotating about a main shaft; and
two support members, separately arranged on one end of the base member corresponding to the axial direction of the main shaft;
whereby a wire-shaped body to be coiled is wound on the support members wherein the wire-shaped body is wound on the support members when the base member rotates forward along the coiling direction, and the wire-shaped body coiled on the support members is loosened when the base member rotates in a direction opposite to the coiling direction.

2. The wire-shaped body winding mechanism of claim 1, wherein each support member rotates on the base member about a split shaft, and each split shaft is parallel to the main shaft.

3. The wire-shaped body winding mechanism of claim 1, wherein each support member has a coiling surface with a low friction coefficient to be in contact with the wire-shaped body to be coiled.

4. The wire-shaped body winding mechanism of claim 1, wherein the base member has a first limiting end surface and a second limiting end surface, the second limiting end surface is separated from the first limiting end surface in the axial direction of the main shaft so as to form a limiting space, and the support members are disposed in the limiting space.

5. The wire-shaped body winding mechanism of claim 1, further comprising an elastic member disposed on the base member and used for enabling the base member to rotate about the main shaft.

6. The wire-shaped body winding mechanism of claim 5, wherein the elastic member is an annular volute spring for providing an elastic force that enables the base member to rotate forward along the coiling direction.

7. The wire-shaped body winding mechanism of claim 1, further comprising a housing seat wherein the base member is disposed in the housing seat.

8. A motion platform having a wire-shaped body winding mechanism, comprising:
a fixed seat;
a movable seat, slidably disposed on the fixed seat and capable of performing reciprocating displacement linearly;
a wire-shaped body winding mechanism according to any one of claims 1, fixedly disposed on the fixed seat; and
a wire-shaped body, wound in the winding mechanism, and having one end electrically connected to the movable seat.

9. A motion platform having a wire-shaped body winding mechanism, comprising:
a fixed seat;
a movable seat, slidably disposed on the fixed seat and capable of performing reciprocating displacement linearly;
a wire-shaped body winding mechanism according to any one of claims 1, slidably disposed on the fixed seat; and
a wire-shaped body, wound in the winding mechanism, and having one end electrically connected to the movable seat.
